(19) United States
(12) Patent Application Publication
(10) Pub. No.: US 2008/0173180 A1
(43) Pub. Date: Jul. 24, 2008

(54) MACHINE WITH AUTOMATICALLY SEALED BREWING CHAMBER

(75) Inventors: Cornelius Boerner, Kuchen (DE); Sander Dollner, Ulm-Wiblingen (DE); Armin Startz, Weidenstetten (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: WMF WURTTEMBERGISCHE METALLWARENFABRIK AG, Geislingen (DE)

(21) Appl. No.: 11/971,363

(22) Filed: Jan. 9, 2008

(30) Foreign Application Priority Data
Jan. 24, 2007 (EP) 07001476.6

(51) Int. Cl. A47J 31/44

(52) U.S. Cl. 99/279

(57) ABSTRACT

A machine for the preparation of a hot drink with a housing and a brewing chamber, wherein the housing is provided with a connection region through which the brewing water is passed to the upper part of the brewing chamber. In order to seal the inflowing brewing water against the environment at the connecting point between the housing and the brewing chamber in a simple, economical and wear-resistant manner without complex locking mechanisms being needed, a seal is inserted into the upper part of the brewing chamber, wherein the seal and the connection region are automatically pressed together when the brewing chamber is inserted into the machine such that the connecting point between the connection region and the upper part of the brewing chamber is sealed against the environment.

### FIELD OF DISCLOSURE

The present application claims the benefit of priority of European Patent Application No. 07001476.6, filed on Jan. 24, 2007. The entire text of the priority application is incorporated herein by reference in its entirety.

The disclosure relates to a machine for preparing a hot drink, such as a coffee drink machine.

### BACKGROUND

Machines of this nature, in particular coffee machines, in which brewing water is passed over the brewing medium, e.g. grounds, under pressure, are already known from the state of the art.

Coffee machines of this nature have a brewing chamber, which is sealed against the environment during brewing. The brewing chamber is here generally realized in two parts with at least one part being arranged movable on the machine. In WO2005/072572 a drawer, for example, is described which represents the lower part of the brewing chamber. The upper part of the brewing chamber is fastened to the machine. In EP090471A1 a further method of realizing a brewing chamber of this nature is described. Here, the upper part of the brewing chamber is supported for swiveling.

With all machines the brewing water must be fed to the brewing chamber under pressure. To do this, the joint connection between the brewing water pipe and the brewing chamber must also be sealed against the environment.

Due to this necessary joining of the upper part of the brewing chamber to the machine, the upper part of the brewing chamber cannot be separated from the appliance, or can only be joined to the appliance with complicated and cost-intensive joining mechanisms.

### SUMMARY OF DISCLOSURE

On this basis the object of the present disclosure is to provide a machine for the preparation of a hot drink, which simply and economically facilitates the sealing of the inflowing brewing water at the connection point between the housing and the brewing chamber against the environment without complex sealing mechanisms being required.

According to the disclosure this object is solved in that in the upper part of the brewing chamber a seal is inserted, wherein by inserting the brewing chamber into the machine the seal and the connection region are automatically pressed together such that the connecting point between the connection region and the upper part of the brewing chamber is sealed against the environment.

The present disclosure facilitates reliable sealing between the brewing water connection region, through which brewing water is passed to the upper part of the brewing chamber, and the upper part of the brewing chamber without additional moving parts being required, so that the connection region and the seal can be pressed together already when the brewing chamber is inserted into the machine (i.e. for example, by pushing in). Complex sealing mechanisms can thus be avoided. This means that no eccentrics, plungers on the housing side, etc. are needed. This has a positive effect on the manufacturing costs as well as on the operation and the machine design. Since according to the disclosure no additional moving parts are needed for sealing, there is also no wear due to movement. Since the seal is included in the upper part of the brewing chamber, the complete brewing chamber including the sealing system can be simply removed and cleaned and optionally replaced.

It is advantageous if the seal is formed from elastic material, wherein the seal is automatically compressed in the fitted state by the connection region. In this way the central region of the seal, which is compressed, can at least be partially located on a support for a brewing chamber section. This compression is sufficient to seal the brewing chamber against the housing such that with the introduction of brewing water over the brewing medium, for example the coffee pad, a slight internal pressure can build up in the brewing chamber.

During brewing however the internal pressure in the brewing chamber increases. It is advantageous if the shape of the seal is designed such that with increased internal pressure in the brewing chamber the seal is pressed against the connection region. In this way, depending on the prevailing internal pressure in the brewing chamber, the seal is pressed against the connection region such that a force relationship is established which always seals the inflowing brewing water against the environment.

To achieve this, the seal can, for example, have a central region surrounded by an external region which is spaced from the inner side of the upper part of the brewing chamber and can be pressed against the inner side by an increased pressure in the brewing chamber. The outer region thus transfers the increased pressure in the brewing chamber to the central region of the seal, which is thus pressed more strongly against the connection region.

It is advantageous if the seal is formed such that it essentially extends over the complete upper area of the inner side of the upper part of the brewing chamber, at least however over approximately 25% of the upper area of the inner side. This facilitates an ideal transfer of the internal pressure onto the seal.

According to the present disclosure the seal has an end section, which seals the upper part of the brewing chamber with the lower part of the brewing chamber. Thus the seal for the brewing water pipe can simultaneously be used for sealing the upper part and lower part of the brewing chamber, simplifying the arrangement and rendering it economical. Preferably, the seal is formed in one piece.

According to a preferred embodiment the brewing chamber has in the assembled, closed state a receptacle region, the shape and size of which are formed such that, for example, a pad (coffee pad, tea pad, etc.) with a specified standard size can be accommodated. Then the seal can be formed such that it has a circumferential collar which presses into the pad from above and from the side to hold it and to facilitate a uniform distribution of the brewing water in the pad.

According to a preferred embodiment the housing has a drawer compartment into which the closed brewing chamber can be completely inserted. An embodiment of this nature is particularly advantageous, because the brewing chamber can be completely removed closed and can be opened outside of the machine. The insertion of the brewing chamber facilitates the simple replacement of the brewing chamber in the housing. Thus the connecting point between the connection region and the upper part of the brewing chamber can be sealed against the environment through simply inserting the brewing chamber into the machine.

Here, the connection region, which is arranged in the drawer compartment, and the upper side of the upper part of the brewing chamber are formed such that the central sealing section runs onto the connection region on insertion into the drawer compartment. According to a preferred embodiment the connection region can protrude into the drawer compartment. In order that the central sealing section can easily run on, the upper side of the upper part of the brewing chamber can have an indentation, which extends at least from the central region of the seal outwards in the insertion direction of the brewing chamber. Thus, when the brewing chamber is inserted into the drawer compartment, the connection region, which protrudes into the drawer compartment, is guided in the indentation until it runs onto the seal. For easier insertion of the brewing chamber, the height of the brewing chamber can also increase from the insertion side of the brewing chamber to the central region of the seal. Thus, the brewing chamber can be introduced in a simple manner without the connection region impairing the insertion process.

According to a preferred embodiment of the present disclosure the seal has the additional task of distributing the brewing water in the upper part of the brewing chamber in a star-shaped pattern. The central region of the seal has a pipe section for the brewing water, via which brewing water is distributed downwards to the brewing medium and/or via channels outwards in a star-shaped pattern.

According to a preferred embodiment the seal in the non-inserted state has a convex shape and on its underside has grooves running from the pipe section in a star-shaped pattern outwards which form channels when the seal is fitted flat into the upper part of the brewing chamber. This construction facilitates a particularly economical manufacture of the brewing chamber. An important advantage here is that no additional components are necessary for the distribution channels. A further advantage is that the seal, which can be removed from the brewing chamber and replaced, can be thoroughly cleaned, wherein also the channels can be opened by bending the seal and can thus be cleaned. Thus, no contamination or calcification occurs in the channels.

The connection region of the machine can either be molded directly on the housing, i.e. as a suitable connecting nipple on the housing, or inserted as a separate element into the housing. If the connection region is inserted into the housing as a separate element, there is the possibility, for example, of selecting a suitable elastic material.

### BRIEF DESCRIPTION OF THE DRAWINGS

The present disclosure is explained in more detail below with reference to the following drawings:

FIG. 1 schematically shows a perspective illustration of a machine according to the present disclosure with an inserted brewing chamber.

FIG. 2 schematically shows in a perspective illustration the machine illustrated in FIG. 1 with the brewing chamber removed.

FIG. 3 schematically shows a section through an embodiment of a brewing chamber with a seal according to the present disclosure, which is inserted into the housing.

FIG. 4 shows a section through another embodiment of a brewing chamber with an inserted seal.

FIG. 5 shows an exploded view of the brewing chamber according to the disclosure.

FIG. 6 shows a perspective view of the underside of the upper part of the brewing chamber.

FIG. 7a shows a plan view of the upper part of the brewing chamber.

FIG. 7b shows a section along the line A-A of FIG. 7a.

FIG. 8a shows a plan view of the underside of the seal.

FIG. 8b shows a section along the line B-B of FIG. 8a.

FIG. 8c shows a section along the line C-C of FIG. 8a.

FIG. 9a shows in a perspective illustration the upper side of the seal according to the present disclosure.

FIG. 9b illustrates the underside of the seal according to the present disclosure.

FIG. 10 illustrates a section through the drawer compartment, wherein the connection region is molded onto the housing.

### DETAILED DESCRIPTION

In the following the present disclosure is described in conjunction with a single-cup machine for the preparation of a hot drink. In particular the present disclosure is described in conjunction with a two-part brewing chamber 3, which can be removed complete as one unit from the housing and which can be inserted into the housing. The present disclosure is in particular of advantage for those types of machines, because frequent changing of the brewing chamber medium in the brewing chamber occurs and it must be frequently and easily removed and cleaned. However, the present disclosure is also suitable for multi-cup systems and for systems in which at least the upper part of the brewing chamber is moved out of the housing.

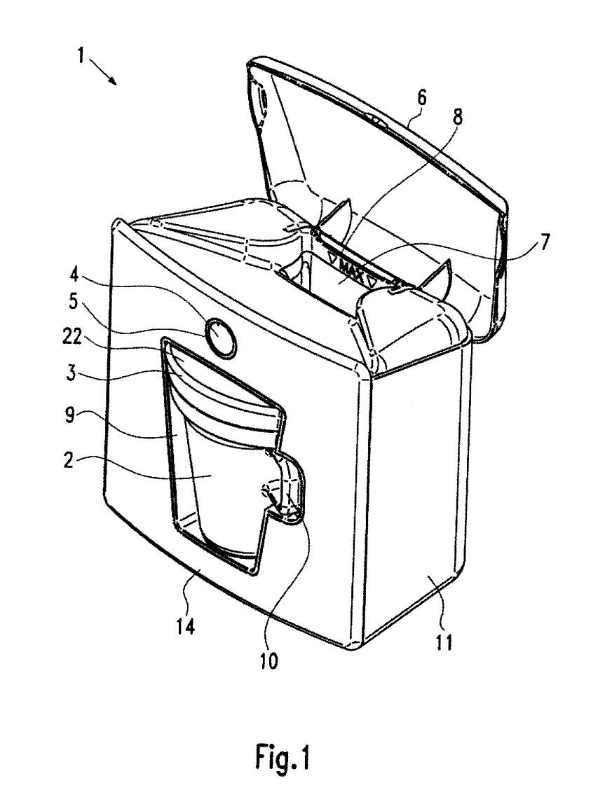

FIG. 1 shows in a perspective illustration a possible embodiment of a machine 1 for the preparation of a hot drink according to the present disclosure. A machine 1 of this nature can for example prepare coffee or tea, etc. The machine 1 has a housing 11, which on its upper side has a cover, with which the housing 11 can be opened and closed. In the housing there is a water tank 7 with a filling-level mark 8, up to which water can be filled for the hot drink. The size or the volume capacity of the water tank 7 is designed such that it can only accept the amount of water required for producing one cup of a hot drink. The predetermined volume is here in a range of 100 to 200 ml depending on the size of the cup. Due to the small water tank volume, the tank is empty at the end of the brewing. Thus, no contamination can occur due to keeping water in the tank for a long period. Furthermore, the machine 1 has a heating system which is not illustrated and which heats the water from the water tank 7. Here, boiler systems or unit heaters can be employed. The heater system is rated such that it is sufficient for heating an amount of water for only one cup of hot drink. The machine 1 therefore has only a brewing amount for which the size and power of the heating system 12 is rated. Consequently, only the amount of energy is passed which is required for providing one cup of brewing water. Furthermore, the machine has a region 9 for the accommodation of a cup 2 into which the hot drink is discharged.

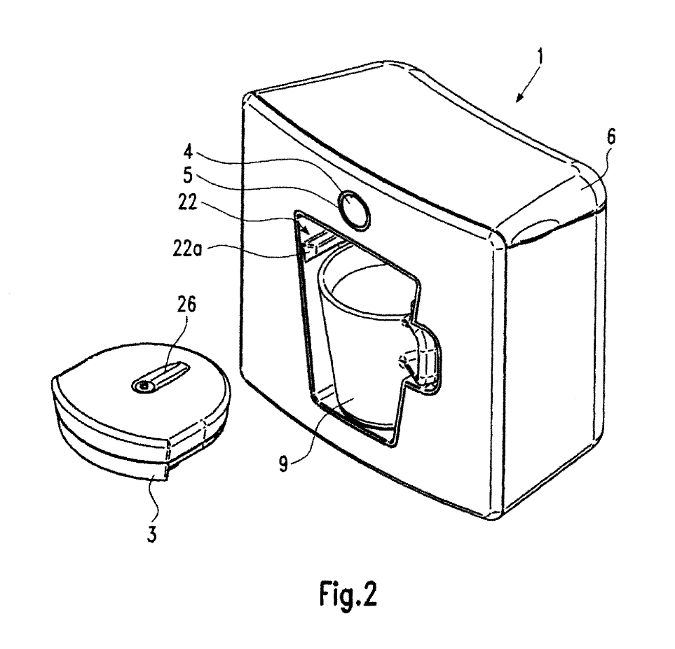

The size of the region 9 is selected such that a cup 2 can be located there. In the upper region 9 there is the drawer chamber 22, into which the brewing chamber 3, as shown in FIG. 1, is inserted, whereas it is completely removed as one unit in FIG. 2. With an inserted brewing chamber 3 a cavity is produced, the longitudinal section of which (parallel to the face side 14 of the housing 11) has a shape which matches the shape of the cup located in it. In order that also cups with handles can be used, the chamber 9 has at least on one side a region which extends from a side wall of the chamber region sidewards and outwards to accommodate for example a handle 10 of the cup 2. This embodiment facilitates a very space-saving arrangement of the region for the accommodation of the cup so that overall space can be saved.

Furthermore, the machine only has one button 4 for the complete operation. The button 4, which is formed here as a pushbutton, has an illuminated indicator 5, here in the form of an illuminated ring 5, which indicates the main operating states. The machine 1 has a control unit which is not illustrated and which controls the heating system, a pump and the illuminated indicator.

According to this embodiment of the present disclosure, the brewing chamber 3 is not fastened to the housing 11, but can instead be completely removed. FIG. 1 illustrates the machine with the brewing chamber 3 completely inserted. FIG. 2 illustrates the machine with the brewing chamber 3 removed. Fully or completely removable means here that both parts, that is the upper part 3b as well as the lower part 3a can be simultaneously removed in the assembled state from the machine. Various brewing media in various forms, such as for example coffee powder or coffee pads, capsules or coffee/tea powder, etc. can be charged into the brewing chamber 3.

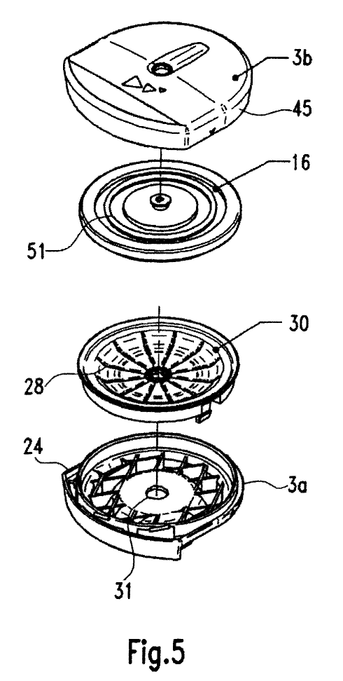

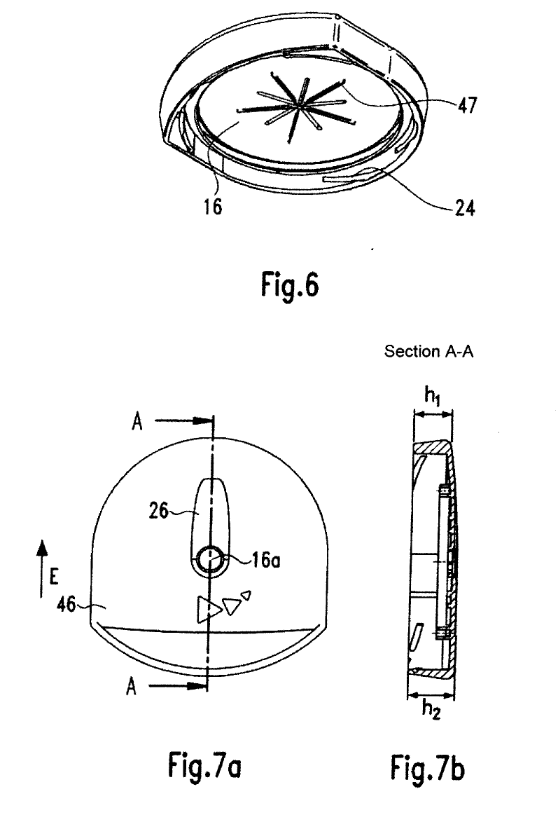

As can be seen, in particular from FIGS. 5 and 6, the brewing chamber 3 here comprises the upper part 3b and the lower part 3a, which can be firmly joined via a locking mechanism 24. A closing mechanism 24 of this nature can for example be realized by thread cams 24 (refer to FIG. 6), or however by a screw lock or a bayonet lock. Locking mechanisms of this nature are extraordinarily low on wear. The two parts of the brewing chamber 3a, 3b each have an appropriate upper 16 and lower 30 insert. The lower insert 30 is inserted into the lower part 3a and has radially extending webs 28 which lead to an outlet 31 of the brewing chamber 3 and which favorably affect the course of the brewed medium to the dispenser 31. The upper insert 16 has various functions and is formed as a seal. FIG. 3 illustrates a possible embodiment of the brewing chamber in the assembled state which is inserted into the drawer compartment 22. The arrow E in FIG. 3 indicates the insertion direction. The upper side 46 of the upper part 3b of the brewing chamber has an opening 50, here essentially in the centre of the brewing chamber. In FIG. 3 the seal 16 can be clearly seen which is here inserted in the upper part 3b of the brewing chamber. The seal 16 is in this embodiment formed from an elastic material, preferably from silicone, which has a Shore hardness in the range of 30-60 Shore, preferably 50 Shore. As for the material for the brewing chamber, the seal must also be compatible with foodstuffs and temperature resistant up to at least 95° C., because it is in direct contact with the brewing medium or brewing water. The seal 16 is formed in one piece. It has a central region 16a, which extends through the opening 50 in the upper part of the brewing chamber to the upper side 46 of the upper part 3b of the brewing chamber and here has a circumferential collar. The pipe section 25, through which the brewing water is passed from the connection region 40, extends through the central region 16a of the seal. The brewing water pipe 18 is provided in the connection region 40. In this embodiment the central region 16a of the seal protrudes at least partially (on the left side in FIG. 3) slightly over the adjacent upper side of the upper part 3b, so that the central region 16a can be compressed by the dimension a. The drawer rail 22a of the housing 11 is dimensioned such that on inserting the brewing chamber 3 into the drawer compartment 22, the brewing chamber 3 takes up an exact position in the housing 11 and the pipe section 25 in the seal 16a is exactly aligned to the connection region 40 and in particular to the brewing water pipe 18. In this way brewing water, which has been pumped out of the water tank 7 with the aid of a pump and which has been heated by the heating system, can be introduced into the brewing chamber 3 via the connection region 40 tinder high pressure. Here, the upper and lower parts of the brewing chamber must be joined together pressure-tight, as will be explained later in more detail.

According to the present disclosure, the seal 16, i.e. the central region 16a of the seal and the connection region 40 are automatically pressed together by insertion—here by the insertion of the brewing chamber 3 into the drawer compartment 22 of the machine 1—such that the connecting point between the connection region 40 and the upper part 3b is sealed against the environment. Since the seal 16 here is formed from elastic material, it is slightly compressed (dimension a) by the connection region 40 which protrudes into the chamber 22. To facilitate this, part of the central region 16a, here the collar, lies on a support 41 of the upper part 3b of the brewing chamber. In addition the complete brewing chamber is located on the drawer rail 22a.

This compression is sufficient to seal the brewing chamber against the housing 11 such that with the introduction of brewing water over the brewing medium 23, a slight internal pressure can build up in the brewing chamber.

The connection region 40 has a chamfer which extends upwards in order that, on inserting the brewing chamber into the drawer compartment 22, the central region 16a can run against the lower area of the connection region 40, so that the central region 16a is automatically pressed down and thus a relatively sealed seating is automatically produced. The collar of the central region 16a of the seal can also be chamfered downwards.

In order that the brewing chamber 3 can be easily inserted into the drawer compartment 22, the height of the brewing chamber 3 can, for example, increase from the insertion side of the brewing chamber 3 to the central region of the seal 16a, as is clear from FIG. 3 and FIG. 7b. FIG. 7b shows that the height h1, which is located on the side which is opposite the housing 11 on inserting the brewing chamber 3, is smaller than the height h2 on the opposite side. For better introduction the upper side 46 of the upper part of the brewing chamber can also have an indentation 26, which at least extends from the central region 16a of the seal outwards in the insertion direction of the brewing chamber 3. The height of the indentation increases slightly against the insertion direction, as can be seen from FIG. 7b. The arrangement indicated above facilitates easy insertion of the brewing chamber, wherein at the same time the brewing chamber is located on the lower rail 22a and also a positive locking joint 60 between the brewing chamber and the housing is produced on the side of the brewing chamber opposite the insertion side.

The compression of the central sealing section 16a explained above thus enables the brewing chamber to be adequately sealed against the housing when a slight internal pressure is established in the brewing chamber 3.

The flat shape of the seal in the brewing chamber enables the seal 16 to be pressed further against the connection region 40 by the internal pressure (dimension b). For this, the seal 16 has a region 16b arranged around the central region 16a and which is spaced from the inner side 42 of the upper part 3b of the brewing chamber by the dimension b and due to an increased pressure in the brewing chamber presses in the direction towards or against the inner side 42 of the upper part 3b of the brewing chamber. Thus the increased pressure in the brewing chamber is transferred to the seal 16, wherein furthermore the central region 16a is pressed against the connection region 40, increasing the sealing performance. Thus, depending on the prevailing internal pressure in the brewing chamber, the seal is pressed against the connection region such that a force relationship is established which always seals the inflowing brewing water against the environment.

The flat-shaped seal 16 is here formed such that it essentially extends over the whole upper area of the inner side 42 of the upper part 3b of the brewing chamber, at least however over 25% of the upper area of the inner side, so that the pressure in the inner chamber can be adequately transferred to the seal and thus to the connection region 40.

In this embodiment the seal is realized in one piece and also has the task of sealing the upper part 3b of the brewing chamber with the lower part 3a of the brewing chamber.

The expression that the region 16b is arranged around the central region 16a is not intended to imply that the outer region 16b, which is spaced from the inner side 42, borders directly with the central region 16a, which extends through the opening 50, as is the case in the figures. It is also possible that the outer region initially borders the inner side 42 and a spacing to the inner side 42 is only produced thereafter in the radial direction.

As can be seen in particular from FIGS. 3 and 9a and 9b, the seal 16 is realized in one piece and in addition to the sealing explained above between the connection region 40 and the upper part 3b of the brewing chamber, it can also take on the task of sealing the upper part of the brewing chamber with the lower part of the brewing chamber. As can be seen in particular from FIGS. 3 and 9a and 9b, for this an end section 16c is provided which extends into the region of the inner area of the side walls 45 of the upper part 3b of the brewing chamber. The end section 16c is here formed such that it contacts the lower insert 30 of the lower part 3a of the brewing chamber, by means of which the joint gap 19 between the upper part and lower part of the brewing chamber is sealed. Since the seal 16 also takes on this sealing function, an extra seal, such as an extra sealing ring, can be omitted. With increasing internal pressure the seal 16 is pressed to an increasing extent against the lower part of the brewing chamber or the corresponding insert 30, so that the sealing effect increases with increasing pressure.

The arising brewing pressure also causes axial forces on the parts of the brewing chamber 3a, b. Pressure on the brewing chamber can be prevented by

a) positively locked joining of the parts of the brewing chamber 3a, b with the housing 11. Here, the dimensions of the drawer compartment 22 and the brewing chamber 3b are formed such that the surface of the upper part 3b and the underside of the lower part 3a contact the drawer compartment 22 at least partially. Thus, the axially acting force can be taken up by the housing 11 with the result that the brewing chamber is not subject to pressure, and

b) the parts of the brewing chamber 3a, b being firmly locked, as previously described, outside of the machine via the locking mechanism 24. This locking system then takes up the arising axial forces. A combination of the measures a and b is particularly effective, in particular in combination with the sealing section 16c.

Advantageously, the drawer compartment 22 is dimensioned such that the brewing chamber 3 partially contacts the drawer compartment at the side. Thus the parts of the brewing chamber 3a, b are also fixed with one another in the radial direction after insertion in the drawer compartment 22. Radial brewing forces are then taken up directly by the parts of the brewing chamber 3a, b and the adjacent housing 11.

As can be seen, in particular from FIGS. 3 and 9a, the seal 16 has a protrusion 51, here an annular protrusion 51, which can be pressed into a corresponding groove in the upper part 3b of the brewing chamber in a simple manner so that the seal 16 can be fixed in the upper part 3b of the brewing chamber, but can at the same time be removed again in a simple manner for cleaning purposes.

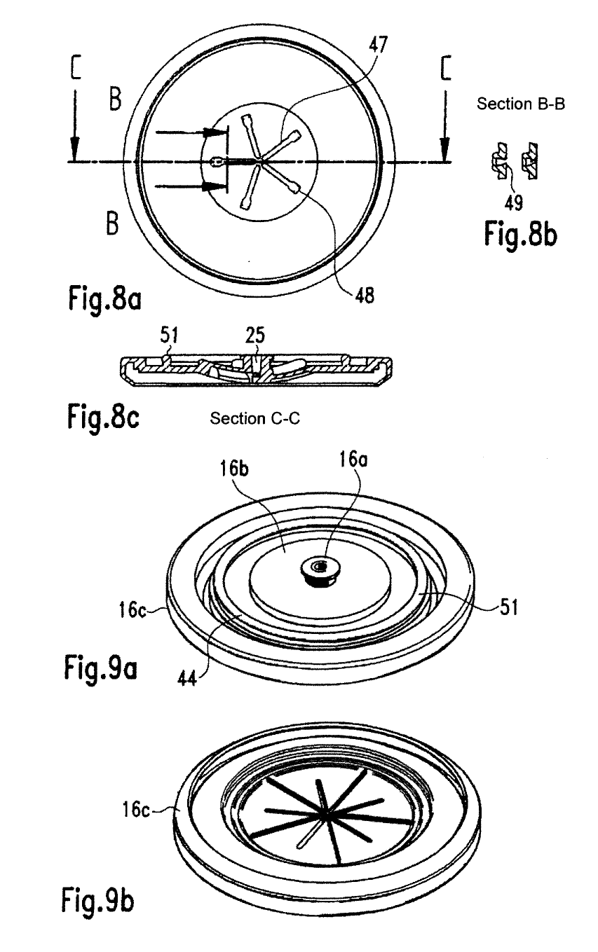

Apart from the function of sealing the connection region 40, which passes the brewing water to the upper part 3b of the brewing chamber, against the upper part of the brewing chamber and optionally also sealing the two halves of the brewing chamber, the seal 16 can take on a further function, namely that of distributing the brewing water in a star-shaped pattern in the upper part of the brewing chamber. As can be clearly seen from FIG. 3, the central region 16a of the seal comprises the pipe section 25 for the brewing water, via which the brewing water is distributed downwards and/or outwards in a star-shaped pattern via channels 47. The channels 47 are located on the underside of the seal 16, as can be seen in particular from FIG. 8a, and are connected on their inner side to the pipe section 25. At their other ends the channels 47 have openings 48 through which the water can be discharged. As can be seen in particular from FIG. 8, the seal is molded in a convex shape for the production of the channels 47. Here, at least the inner region, i.e. the section in which the channels 47 are to run, is formed convex. In this convex region grooves 49 are provided which are open underneath. The grooves here are formed such that the width on the upper side is less than the width on the underside, i.e. the grooves are dimensioned here essentially V-shaped. If the seal 16 is now mounted flat in the upper part of the brewing chamber 3b, the grooves, as shown in FIG. 8b, close to form channels 47 which essentially have a triangular cross-section.

Thus, brewing water channels can be produced in a simple manner without additional components or a complicated manufacturing method being necessary. An embodiment of this nature for the channels 47 also has the advantage that when cleaning the brewing chamber, the seal can be removed, wherein the channels can be opened for cleaning by simply turning the seal 16 inside out and they can also be cleaned in this way.

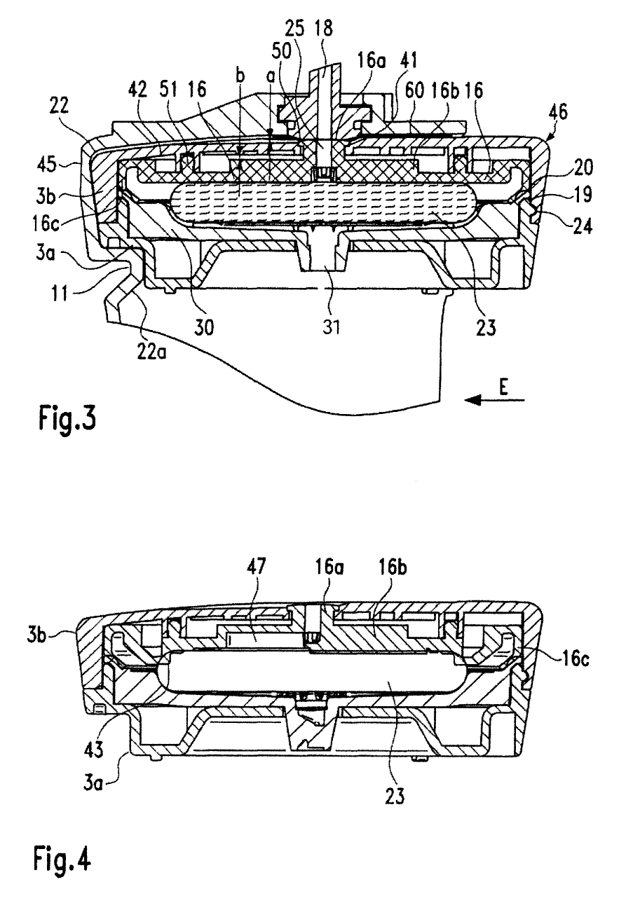

FIG. 4 illustrates a further embodiment of the present disclosure which essentially corresponds to the embodiment illustrated in FIG. 3 with the exception of an additionally formed circumferential collar 43. As can be seen from FIG. 4, the brewing chamber 3 has in the assembled, locked state a receptacle region for the brewing medium 23. The receptacle region for the brewing medium 23 here has for example a shape and size such that a pad, for example for coffee or tea, with predetermined standard size, can be accommodated. The circumferential collar 43 protrudes so far into the receptacle region that it presses in the pad on its circumference at the side and from above. Thus, the pad is held and the uniform distribution of the water is enhanced.

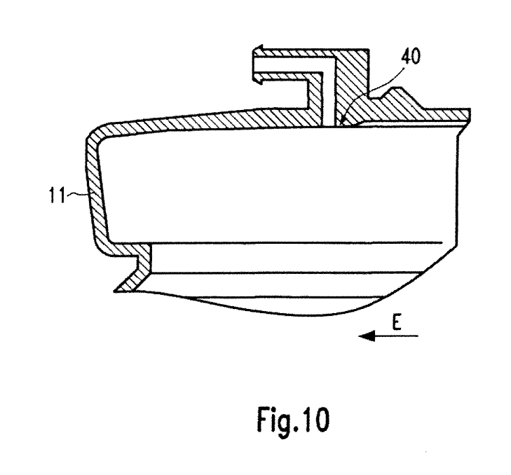

In FIG. 3 the connection region 40 was inserted as a separate element into the housing 11. Thus the connection region 40 can optionally also be produced from a material that differs from the housing material. It is however also possible, as shown in FIG. 10, that the connecting nipple for the brewing water is molded directly in the housing.

According to the present disclosure no additional moving parts are needed for sealing the connection region 40 in the upper part of the brewing chamber, which makes the system extraordinarily economical. Since no moving parts are arranged on the machine, there is no wear due to movement. The complete brewing chamber including the sealing system can be simply removed and cleaned and optionally replaced. In a convenient manner the seal 16 can here take on various functions, such as the sealing of the connection region 40 and of the brewing chamber 3 with low and high pressures in the brewing chamber, sealing of both halves of the brewing chamber and the star-shaped distribution of the brewing water. In particular this sealing system is especially suitable for single-cup systems, because here in each case after one cup, the brewing chamber is removed, emptied, cleaned, filled and used again.

1. Machine (1) for the preparation of a hot drink, comprising a housing (11), a brewing chamber (3), the housing (11) being provided with a connection region (40), through which the brewing water is passed to the upper part (3b) of the brewing chamber, a seal (16) being inserted in the upper part (3b) of the brewing chamber, wherein through the insertion of the brewing chamber (3) into the machine (1), the seal (16) and the connection region (40) are automatically pressed together such that the connecting point between the connection region (40) and the upper part (3b) of the brewing chamber is sealed against the environment.

2. Machine (1) according to claim 1, wherein the seal (16) is formed from elastic material, wherein the seal (16) in the fitted state is compressed by the connection region (40).

3. Machine (1) according to claim 2, wherein the central region (16a) of the seal (16), which is compressible, contacts at least partially a support (41) of the upper part (3b) of the brewing chamber.

4. Machine (1) according to claim 1, wherein the shape of the seal (16) is designed such that with increased internal pressure in the brewing chamber (3) the seal (16) is pressed against the connection region (40).

5. Machine (1) according to claim 1 to, wherein the seal (16) has an external region (16b) surrounding a central region (16a), by external region being spaced from the inner side (42) of the upper part (3b) of the brewing chamber and being pressed in the direction of the inner side by an increased pressure in the brewing chamber.

6. Machine (1) according to claim 1 to 5, wherein the seal (16) is formed such that it essentially extends over the complete upper area of the inner side (42) of the upper part (3b) of the brewing chamber.

7. Machine (1) according to claim 1, wherein the seal (16) has an end section (16c) which seals the upper part (3b) of the brewing chamber with the lower part (3a) of the brewing chamber.

8. Machine (1) according to claim 1, wherein the seal (16) is formed in one piece.

9. Machine (1) according to claim 1, wherein the brewing chamber (3) in the assembled, locked state has a receptacle region, the shape and size of which is formed such that a pad with a predetermined standard size can be accommodated, wherein the seal (16) has a circumferential collar (43), which presses into the pad (23) from above and from the side.

10. Machine (1) according to claim 1, wherein the housing (11) has a drawer compartment (22), into which the closed brewing chamber (3) can be inserted as a complete unit.

11. Machine (1) according to claim 10, wherein the connection region (40) in the drawer compartment (22) and the upper side of the upper part (3b) of the brewing chamber are formed such that the central sealing section (16a) runs onto the connection region (40) on being inserted into the drawer chamber (22).

12. Machine (1) according to claim 11, wherein the upper side (46) of the upper part (3b) of the brewing chamber has an indentation (26), which indentation (26) at least extends from the central region (40a) of the seal (16) outwards in the insertion direction of the brewing chamber (3).

13. Machine (1) according to claim 11, wherein the height of the brewing chamber increases from the insertion side of the brewing chamber (3) to the central region of the seal (16a).

14. Machine (1) according to claim 1, wherein in the central region (16a) of the seal a pipe section (25) for the brewing water is provided, through which pipe section (25) brewing water is distributed one of downwards to the brewing medium and radially outwards by channels (47).

15. Machine (1) according to claim 14, wherein in the non-fitted state the seal (16) has at least in the inner region a convex shape and on its underside has grooves (49) extending from the pipe section (25) in a star shape outwards, with the groves (49) closing to form channels (47) when the seal is fitted flat in the upper part (3b) of the brewing chamber.

16. Machine (1) according to claim 14, wherein the seal (16) is arranged in the brewing chamber (3) such that it can be removed and inserted again.

17. Machine (1) according to claim 1 wherein, the connection region (40) is one of molded directly on the housing (11) or is inserted as a separate element into the housing (11).

18. Machine (1) according to claim 6, wherein the seal (16) extends at least one 25% of the upper area of the inner side.
